(19) United States
(12) Patent Application Publication
(10) Pub. No.: US 2021/0248465 A1
(43) Pub. Date: Aug. 12, 2021

(54) HIERARCHICAL MULTI-AGENT IMITATION LEARNING WITH CONTEXTUAL BANDITS

(71) Applicant: NEC Laboratories America, Inc., Princeton, NJ (US)

(72) Inventors: Wenchao Yu, Plainsboro, NJ (US); Haifeng Chen, West Windsor, NJ (US); Wei Cheng, Princeton Junction, NJ (US)

(21) Appl. No.: 17/167,890

(22) Filed: Feb. 4, 2021

Related U.S. Application Data
(60) Provisional application No. 62/975,307, filed on Feb. 12, 2020.

(51) Int. Cl. G06N 3/08; G06N 3/04

(52) U.S. Cl. CPC G06N 3/08; G06N 3/0454

(57) ABSTRACT

A computer-implemented method is provided for hierarchical multi-agent imitation learning. The method includes learning sub-policies for sub-tasks of a hierarchical multi-agent imitation learning task by imitating expert trajectories of expert demonstrations of the subtasks with guidance from a high-level policy corresponding to the hierarchical multi-agent imitation learning task. The method further includes collecting feedback from the sub-policies relating to updating the high-level-policy with a new observation. The method also includes updating the high-level policy with the new observation responsive to the feedback from the sub-policies. The high-level policy is configured as a contextual multi-arm bandit that sequentially selects k best sub-policies at each of a plurality of time steps based on contextual information derived from the expert demonstrations

### RELATED APPLICATION INFORMATION

This application claims priority to U.S. Provisional Patent Application No. 62/975,307, filed on Feb. 12, 2020, incorporated herein by reference entirety.

### BACKGROUND

### Technical Field

The present invention relates to machine learning and more particularly to hierarchical multi-agent imitation learning with contextual bandits.

### Description of the Related Art

Given a set of expert demonstrations, imitation learning has been proved to be very effective in replicating expert behaviors without access to explicit reward signals. Complex tasks, such as dynamic treatment recommendation for patients with comorbidities, however, often show significant variability in expert demonstrations with multiple sub-tasks. It can be challenging to represent a structured task by imitating a single policy without modeling the sub-structures explicitly. Existing work improves the performance of imitation learning by learning sub-policies for different sub-tasks. However, these approaches cannot simultaneously learn a high-level policy to compose the learned sub-policies while adapting its high-level policy based on the feedback from the sub-policies to maximize the total rewards in the long run.

### SUMMARY

According to aspects of the present invention, a computer-implemented method is provided for hierarchical multi-agent imitation learning. The method includes learning sub-policies for sub-tasks of a hierarchical multi-agent imitation learning task by imitating expert trajectories of expert demonstrations of the subtasks with guidance from a high-level policy corresponding to the hierarchical multi-agent imitation learning task. The method further includes collecting feedback from the sub-policies relating to updating the high-level-policy with a new observation. The method also includes updating the high-level policy with the new observation responsive to the feedback from the sub-policies. The high-level policy is configured as a contextual multi-arm bandit that sequentially selects k best sub-policies at each of a plurality of time steps based on contextual information derived from the expert demonstrations.

According to other aspects of the present invention, a computer program product is provided for hierarchical multi-agent imitation learning. The computer program product includes a non-transitory computer readable storage medium having program instructions embodied therewith. The program instructions are executable by a computer to cause the computer to perform a method. The method includes learning sub-policies for sub-tasks of a hierarchical multi-agent imitation learning task by imitating expert trajectories of expert demonstrations of the subtasks with guidance from a high-level policy corresponding to the hierarchical multi-agent imitation learning task. The method further includes collecting feedback from the sub-policies relating to updating the high-level-policy with a new observation. The method also includes updating the high-level policy with the new observation responsive to the feedback from the sub-policies. The high-level policy is configured as a contextual multi-arm bandit that sequentially selects k best sub-policies at each of a plurality of time steps based on contextual information derived from the expert demonstrations.

According to yet other aspects of the present invention, a computer processing system is provided for hierarchical multi-agent imitation learning. The computer processing system includes a memory device for storing program code. The computer processing system further includes a processor device operatively coupled to the program code for running the program code to learn sub-policies for sub-tasks of a hierarchical multi-agent imitation learning task by imitating expert trajectories of expert demonstrations of the subtasks with guidance from a high-level policy corresponding to the hierarchical multi-agent imitation learning task. The processor device further runs the program code to collect feedback from the sub-policies relating to updating the high-level-policy with a new observation. The processor device also runs the program code to update the high-level policy with the new observation responsive to the feedback from the sub-policies. The high-level policy is configured as a contextual multi-arm bandit that sequentially selects k best sub-policies at each of a plurality of time steps based on contextual information derived from the expert demonstrations.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a block diagram showing an exemplary hierarchical architecture, in accordance with an embodiment of the present invention;

FIG. 3 is a high-level diagram showing an exemplary system/method for model training, in accordance with an embodiment of the present invention;

FIG. 4 is a high-level diagram showing an exemplary system/method for model inference, in accordance with an embodiment of the present invention; and

FIG. 5 is a flow diagram showing an exemplary method in accordance with an embodiment of the present invention.

### DETAILED DESCRIPTION OF PREFERRED EMBODIMENTS

Embodiments of the present invention are directed to hierarchical multi-agent imitation learning with contextual bandits.

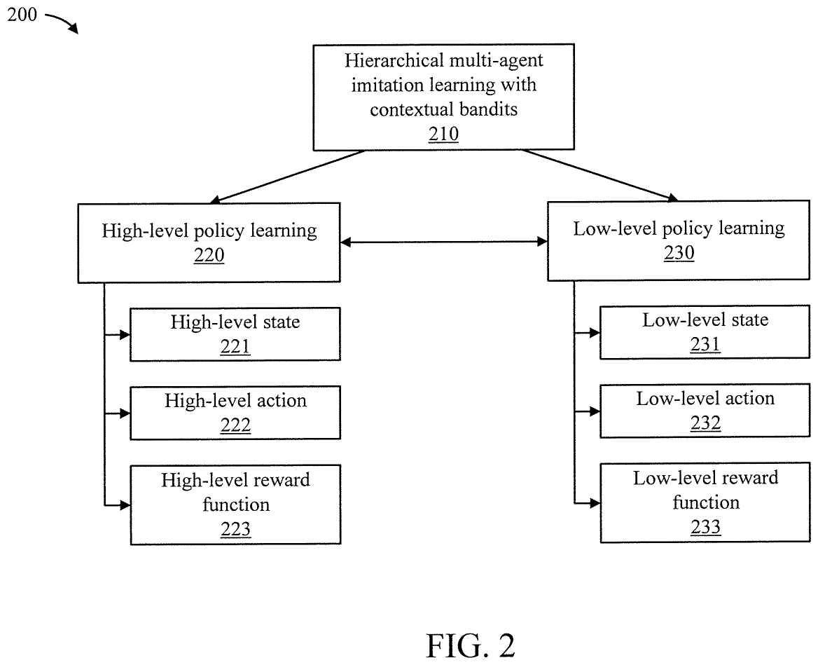

In one or more embodiments of the present invention, a hierarchical multi-agent imitation learning model, HMAIL, is proposed to infer the latent interactions among sub-tasks of the expert demonstrations with contextual bandits act as a high-level policy to combine the learned sub-policies in a meaningful way to imitate complex behaviors. Specifically, the present invention learns sub-policies by imitating the expert trajectories with the guidance from the high-level policy. Meanwhile, the present invention collects the feedback from the sub-policies to help update the high-level policy, which is formulated as a contextual multi-arm bandit to sequentially select the best sub-policies at each time step based on the contextual information derived from the demonstrations. As illustrated in FIG. 2, an instantiation of the present invention is shown in the health care domain for the sake of illustration. Patients with comorbidities may have more than one disease. The treatment of each disease can be viewed as a sub-task solution. And the doctors have to compose different treatments in a meaningful way for comorbidity patients in order to increase the survival rate. In an embodiment, the present invention is configured to learn meaningful sub-policies and composite sub-policies to accurately reproduce the desired complex task with the real-world medical data. Compared with various baselines, the present invention improves the likelihood of patient survival and provides better dynamic treatment regimens with the exploitation of hierarchical structure from the expert demonstrations.

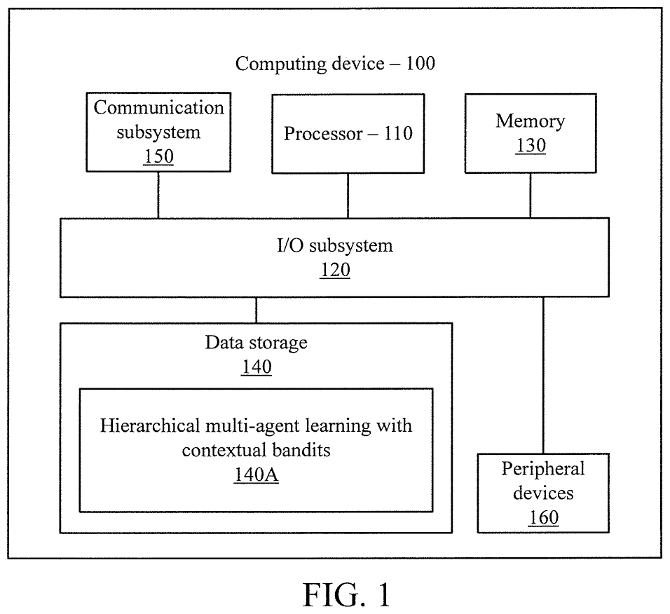

FIG. 1 is a block diagram showing an exemplary computing device 100, in accordance with an embodiment of the present invention. The computing device 100 is configured to perform hierarchical multi-agent imitation learning with contextual bandits.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for hierarchical multi-agent imitation learning with contextual bandits. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. Further, in another embodiment, a cloud configuration can be used. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

A description will now be given regarding hierarchical multi-agent imitation learning with contexture bandits, in accordance with an embodiment of the present invention.

FIG. 2 is a block diagram showing an exemplary hierarchical architecture 200, in accordance with an embodiment of the present invention.

Hierarchical policy achieves significant improvement in solving complex functions. The proposed hierarchical imitation learning method composes multiple sub-policies via contextual bandits. These sub-policies are automatically learned for solving specific sub-tasks. The present invention builds upon the standard imitation learning formulation, which is an alternative to the reinforcement learning setting where the policy is learned directly from the demonstrations rather than from the reward signal of an environment. In an embodiment, the present invention can be considered to include the following two components: (1) Contextual bandits for composing multiple sub-policies; and (2) imitation learning for each sub-policy to generate basic skills in shorten horizon.

Hierarchical multi-agent imitation learning with contexture bandits 210 involves high level policy learning 220 and low-level policy learning 230.

A description will now be given regarding high-level policy learning 220, in accordance with an embodiment of the present invention.

High-level policy is learned to compose multiple sub-policies via a contextual bandits algorithm. The contextual bandit algorithm observes the current state which referred as context (for example the symptom of the patients), and the k sub-policies which represent the arms (for example experts in different domains). Considering the observed reward in previous trials (for example the similarity between doctors action and sub-policies' action), at time step t, high-level policy chooses an arm with the highest upper confidence bound, and obtains reward r. High-level policy improves with the new observation (sₜ, aₜ, rₜ).

High level policy learning 220 involves a high-level state ( [symbol] ) 221, a high-level action ( [symbol] ) 222, and a High-level reward function (R) 223.

Regarding the high-level state ( [symbol] ) 221, the same indicates the context of the current status, e.g., the symptom of the patients.

Regarding high-level action ( [symbol] ) 222, in dynamic treatment recommendation task, the actions are the treatments, i.e., the combination of the medications.

Regarding high-level reward function (R) 223, high-level policy obtains its reward at each timestep by comparing the selection actions against the experts' actions.

A description will now be given regarding low-level policy learning 230, in accordance with an embodiment of the present invention.

The high-level policy shortens the respective horizon for each sub-policy, which can be considered as dividing the complex task into multiple sub-tasks. These sub-policies can be simple or even sub-optimal. The present invention instances this framework with behavior cloning and adversarial imitation learning.

Low-level policy learning 230 involves a low-level state ( [symbol] ) 231, a low-level action ( [symbol] ) 232, and a low-level reward function (R) 233.

Regarding the low-level state ( [symbol] ) 231, the same indicates the context of the current status, e.g., the symptom of the patients. The high-level and low-level policies share the same state generation method.

Regarding the low-level action ( [symbol] ) 232, low level actions are generated by each individual sub-policy. It is a combination of the medications for sub-tasks.

Regarding the low-level reward function (R) 333, high-level policy requires the reward signal from low-level policies. In an embodiment of the present invention, the imitation reward is obtained by the cross entropy as follows:

r_{t,k}=−Σ_{c=1}^{M}π_{E}(a^{c}|sₜ)log π_{t,k}(a^{c}|sₜ)

where a_{c} is the c^{th} action and M is the total number of actions, r_{t,k} represents the reward of the k^{th} action at time step t, π_{E} represents the expert policy, π_{t,k} represents the learned k^{th} sub-policy at time step t, and sₜ represents the state vector at time step t.

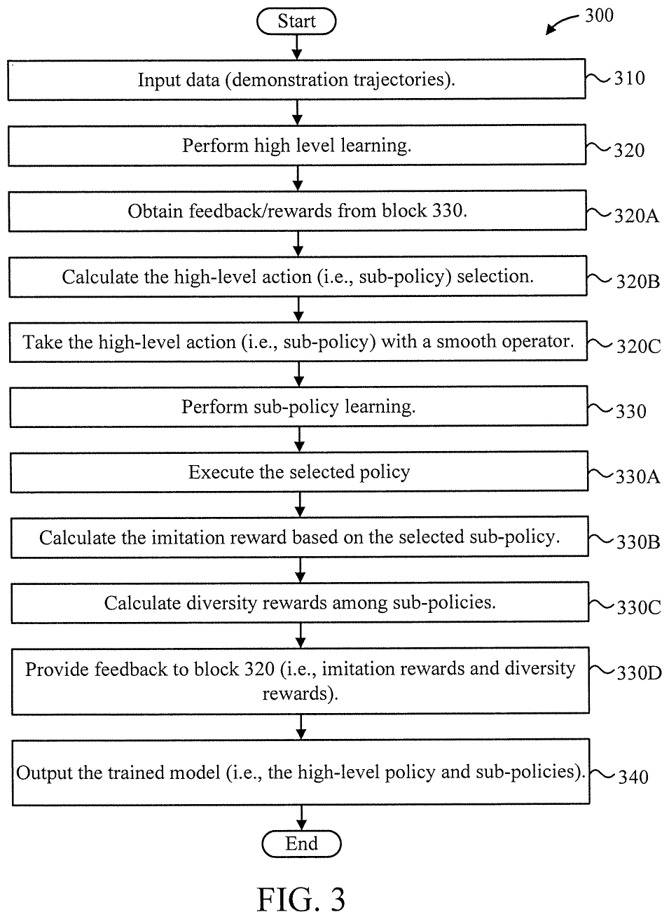

FIG. 3 is a flow diagram showing an exemplary method 300 for model training, in accordance with an embodiment of the present invention.

Method 300 includes blocks 310 through 340, where blocks 320-330 are iteratively performed until some criteria is met (convergence, etc.).

At block 310, input data (demonstration trajectories).

At block 320, perform high level learning.

In an embodiment, block 320 can include one or more of blocks 320A through 320C.

At block 320A, obtain feedback/rewards from block 330 (in subsequent iterations).

At block 320B, calculate the high-level action (i.e., sub-policy) selection.

At block 320C, take the high-level action (i.e., sub-policy) with a smooth operator.

At block 330, perform sub-policy learning.

In an embodiment, block 330 can include one or more of blocks 330A through 330D.

At block 330A, execute the selected policy.

At block 330B, calculate the imitation reward based on the selected sub-policy.

At block 330C, calculate diversity rewards among sub-policies.

At block 330D, provide feedback to block 320 (i.e., imitation rewards and diversity rewards).

At block 340, output the trained model (i.e., the high-level policy and sub-policies).

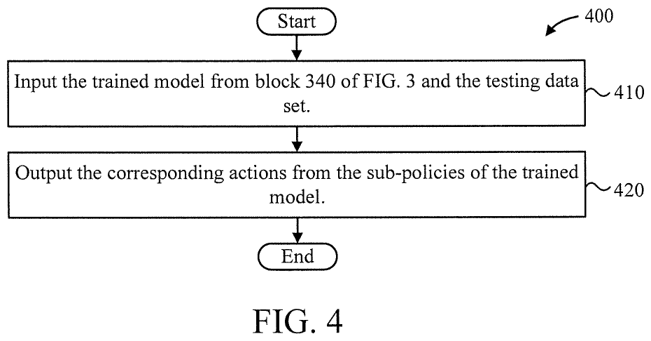

FIG. 4 is a flow diagram showing an exemplary method 400 for model inference, in accordance with an embodiment of the present invention.

At block 410, input the trained model from block 340 of FIG. 3 and the testing data set.

At block 420, output the corresponding actions from the sub-policies of the trained model.

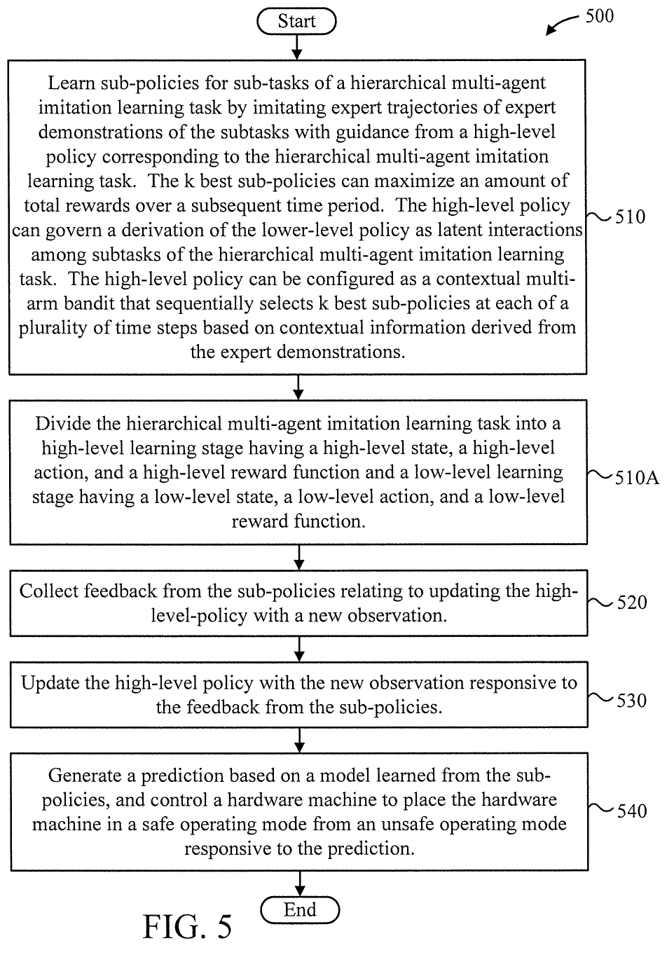

FIG. 5 is a flow diagram showing an exemplary method 500, in accordance with an embodiment of the present invention.

At block 510, learn sub-policies for sub-tasks of a hierarchical multi-agent imitation learning task by imitating expert trajectories of expert demonstrations of the subtasks with guidance from a high-level policy corresponding to the hierarchical multi-agent imitation learning task. In an embodiment, the k best sub-policies can maximize an amount of total rewards over a subsequent time period. In an embodiment, the hierarchical multi-agent imitation learning can be configured to generate basic skills in a given domain. In an embodiment, the high-level policy can govern a derivation of the lower-level policy as latent interactions among subtasks of the hierarchical multi-agent imitation learning task.

In an embodiment, the high-level policy can be configured as a contextual multi-arm bandit that sequentially selects k best sub-policies at each of a plurality of time steps based on contextual information derived from the expert demonstrations. In an embodiment, the sub-policies can represent arms of the contextual multi-arm bandit. In an embodiment, the contextual multi-arm bandit observes a current state and the sub-policies, wherein the sub-policies are considered arms of the contextual multi-arm bandit corresponding to different expert demonstration domains. In an embodiment, the current state can include multiple symptoms of the patient relating to comorbidity, and the arms can include doctors in different departments.

In an embodiment, block 510 can include block 510A.

At block 510A, divide the hierarchical multi-agent imitation learning task into a high-level learning stage having a high-level state, a high-level action, and a high-level reward function and a low-level learning stage having a low-level state, a low-level action, and a low-level reward function.

At block 520, collect feedback from the sub-policies relating to updating the high-level-policy with a new observation.

At block 530, update the high-level policy with the new observation responsive to the feedback from the sub-policies.

At block 540, generate a prediction based on a model learned from the sub-policies, and control a hardware machine to place the hardware machine in a safe operating mode from an unsafe operating mode responsive to the prediction.

A description will now be given regarding Hierarchical Imitation Learning with Contextual Bandits for Dynamic Treatment Regimes, in accordance with an embodiment of the present invention.

The description will commence with preliminaries. The preliminaries will commence with contextual bandits.

The goal of multi-armed bandit is to find an optimal strategy in finite steps with maximized Regret [symbol] [Σₜ₌₁^{T} r_{t,a*}_{ₜ}]− [symbol] [Σₜ₌₁^{T} r_{t,a}_{ₜ}] between the agent's action aₜ and the optimal action a_{*t} at each time step. Multi-armed bandit algorithms solve this problem by balancing two factors: 1) exploiting agent's past experience to select the best arm so far; 2) exploring more actions to find a better strategy. Upper confidence bound is one of the most effective bandit algorithm, which selects the actions based on highest upper confidence bound aₜ=arg maxₐ(\hat{r}_{t,a}+c_{t,a}]), where \hat{r}_{t,a} is the mean reward of action a and c_{t,a} is the confidence interval. Contextual bandits consider the contextual information Sₜ to take an action which is particularly useful in many real-world problem such as personalized recommendation. It takes actions with highest upper confidence bound by considering the contextual information: =arg maxₐ(Sₜ^{T}R_{t,a}+c_{t,a}]), where R_{t,a} is the rewards collected until time step t.

A description will now be given regarding Imitation Learning, in accordance with an embodiment of the present invention.

Generally, given a set of experts' demonstration trajectories τ, which consists of sequences of states and actions ( [symbol] ₀, a₀, [symbol] ₁, a₁, . . . ) drawn from the expert policy π_{E}, the goal of imitation learning is to learn a policy π_{θ}(a|s) which can replicate experts' behaviors. The imitation learning methods can be generally grouped into three categories: behavior cloning (BC), inverse reinforcement learning (IRL) and adversarial imitation learning (AIL). Herein, focus is made on BC and AIL which learn policies directly from the demonstrations.

A description will now be given regarding behavior cloning, in accordance with an embodiment of the present invention.

BC aims to learn the policy π_{θ}(a|s) via supervised learning. Given the fixed action space or classes, BC learns a policy mapping from states to experts' actions with the tuple datasets {( [symbol] ₀, a₀), ( [symbol] ₁, a₁), . . . },

$${argmin}_{θ} {𝔼}_{( s , a ) \sim P *} L ( a , {π}_{θ} ( s ) ) \qquad ( 1 )$$

where P*=P (s|π*) is the distribution of states visited by expert. Due to the standard i.i.d. assumption in the supervised learning, the errors induced by BC are compounding over the length of the trajectories.

A description will now be given regarding Adversarial Imitation Learning, in accordance with an embodiment of the present invention.

Adversarial imitation learning directly learns π_{θ} by minimizing the Jensen-Shannon divergence between expert's policy π_{E} and the learned policy π_{θ},

$${D}_{J S} ( {ρ}_{{π}_{θ}} , {ρ}_{{π}_{E}} ) = {D}_{K L} ( {ρ}_{{π}_{θ}} ‖ \frac{{ρ}_{{π}_{θ}} + {ρ}_{{π}_{E}}}{2} ‖ ) + {D}_{K L} ( {ρ}_{{π}_{E}} ‖ \frac{{ρ}_{{π}_{θ}} + {ρ}_{{π}_{E}}}{2} ‖ )$$

where the occupancy measure ρ_{π}=π(a|s)Σₜ₌₀^{T} γ P(sₜ=(s|π) is the distribution of state-action pairs that the policy π interacts with the environment. γ is the discounting factor, and the successor states are drawn from P(s|π) AIL utilizes a generative adversarial network to minimize the Jensen-Shannon divergence via a generator π_{θ} and a discriminator D(⋅) with the following objective function as follows:

$$D ∈ {max}_{0 , 1} s \times {𝒜𝔼}_{ρ π σ} [ log ( D ( s , a ) ) ] + {𝔼}_{ρ π E} [ log ( 1 - D ( s , a ) ) ] , \qquad ( 2 )$$

where [symbol] is the state set, and [symbol] is the action set.

A description will now be given regarding Hierarchical Imitation Learning with Contextual Bandits, in accordance with an embodiment of the present invention.

HIL includes two phases: 1) High-level policy learning with contextual bandits to compose multiple sub-policies; 2) Sub-policy learning via imitation learning with shortened horizons. The high-level policy π^{h} is implemented with a K-arm contextual bandit. The contextual bandit observes the current state sₜ and selects a sub-policy πₖ^{s}, κϵ[1, K]. The selected sub-policy πₖ^{s} generates an action aₜ conditioned on sₜ. The goal of the high-level policy π^{h} is to find an effective way to compose the sub-policies πₖ^{s} to mimic the expert demonstrations.

A description will now be given regarding High-level Policy Learning with Contextual Bandits, in accordance with an embodiment of the present invention.

The traditional imitation learning framework is extended by assuming there exits finite sub-policies with different behaviors Π={πₖ^{s}}Kₖ₌₀. HIL learns a high-level policy π^{h} parameterized with Θ (Θ={θ₁, . . . , θ_{K}} to compose these K sub-policies via contextual bandits algorithm where the primitive agents learn their sub-policy by imitation learning methods such as behavioral cloning and adversarial imitation learning.

Given the expert demonstrations T=(s₀, a₀, . . . , s_{T}, a_{T}), HIL selects a set of sub-policies to take actions and generates the trajectory (s₀, A₀, . . . , s_{T}, A_{T}). Specifically, given the state sₜϵ [symbol] ^{d}, it is assumed the expected reward of arm Aₖ is linear in the state sₜ with some unknown coefficients θ*_{t,k}ϵ [symbol] ^{d} such that the reward signal in state sₜ obtained by the high-level policy π^{h} is r_{t,k}(sₜ,A^{k})=θ*_{t,k}^{T} sₜ+ηₜ, where ηₜ is σ-subgaussian random variable with [symbol] (ηₜ)=0 and [symbol] (ηₜ²)≤σ² utilized to model the additional noise to the reward signal. The reward signal is bounded in the range 0 to 1. The matrix X_{t,k}ϵ [symbol] ^{m×d} is used to represent the states, where each row indicates the observed state representation that belongs to the selected A^{k} up to time step t. In addition, R_{t,k}ϵ [symbol] ^{m} is used to denote the rewards, where each element indicates the imitation reward r_{t,k} (described in Eq. (8) and (11)) achieved by A^{k} up to time step t. The linear contexture bandits are considered here, thus the loss function is defined as follows:

$${ℒ}_{θ , t , k} = ‖ {X}_{t , k} {θ}_{t , k} - {R}_{t , k} ‖ \frac{2}{2} + λ ‖ {θ}_{t , k} ‖ \frac{2}{2} , \\ {ℒ}_{θ , t , k} = ‖ {X}_{t , k} {θ}_{t , k} - {R}_{t , k} ‖ \frac{2}{2} + λ ‖ {θ}_{t , k} ‖ \frac{2}{2} , \qquad ( 3 )$$

where λ>0 regulates the weight decay term. Applying ridge regression to the training data (X_{t,k}, R_{t,k}) gives the estimation of the arm parameters as follows:

θ_{t,k}=(X_{t,k}^{T}X_{t,k}+λI_{t,k})⁻¹X_{t,k}^{T}R_{t,k}, (4)

where I_{t,k}ϵ [symbol] ^{d×d} is the identity matrix. With the assumption that the expectation of reward signal is linear in the state sₜ, the probability 1−δ can be obtained to choose the valid sub-policy for the state sₜ, as shown in Section A in the Appendix.

A description will now be given regarding a smoothness constraint, in accordance with an embodiment of the present invention.

With the observation that states are changing gradually, HIL encourages smoothness in the sequential sub-policy selection with a smooth operator Δ(⋅) as follows:

smooth_{α}:= [symbol] →Δ( [symbol] ), (5)

where α≥0 is the reward threshold. When the upper confidence bound of the selected arm (sub-policy) is larger than the arm selection is updated, otherwise the previous selection is kept.

A description will now be given regarding a Diversity Constraint, in accordance with an embodiment of the present invention. Diversified sub-policies help learn complex task with multiple modes or hierarchical structure. Thus the reward function is designed to enforce diversity of the learned K sub-policies. The diversity constraint is defined as follows:

rₜ^{div}=Σᵢ₌₀^{K}Σⱼ₌₀^{K}W(πᵢ^{s},πⱼ^{s})

where W (πᵢ^{s},πⱼ^{s}) is the Wasserstein distance between πᵢ^{s} and πⱼ^{s}. rₜ^{div} is used as feedback to help update π^{h} where R_{t,:}+rₜ^{div}. One of the advantages of utilizing contextual bandits to compose multiple sub-policies is that contextual bandits' choices will not change the state which simplify the Markov decision processes. Additionally, contextual bandits find the valid sub-policy very quick with this simplification, which makes the low-level policy learning more stable.

A description will now be given regarding Sub-policy Learning via Imitation, in accordance with an embodiment of the present invention.

The second phase of HIL is to learn sub-policies with imitation learning. HIL can incorporate any imitation learning method to mimic the expect demonstrations. Here, the proposed HIL model is instantiated with behavioral cloning and adversarial imitation learning.

A description will now be given regarding pre-training, in accordance with an embodiment of the present invention.

In order to initialize explainable and diverse sub-policies for stable training, the actions taken by the experts are clustered into K groups with k-means clustering. Then the sub-policies can be initialized by training on different clusters. Note that clustering algorithms are not applied on states because the states are not fully observed.

A description will now be given regarding HIL with Behavioral Cloning, in accordance with an embodiment of the present invention.

Behavior cloning suffers from distribution mismatch between behavior policy in long-horizon task. The use of HIL framework can help reduce this compounding error with a shortened horizon because π^{h} allocates the sub-policies only with a limited number of states. Given expert trajectories τ=( [symbol] ₀, a₀, ( [symbol] ᵢ, . . . , s_{T}) generated from policy π_{E}, the high-level policy π^{h} sequentially selects sub-policies to take an action, which explicitly breaks down τ into a set of sub-trajectories τ⁰, . . . , τ^{K} for sub-policies. The agents collect the states from the allocated sub-trajectories by π^{h}. Let π_{t,k}^{s} (parameterized with ϕₖ, ϕₖϵΦ, Φ={ϕₖ, . . . , ϕₖ}) indicates the agent selected by π^{h} at time step t, each sub-policy πₖ^{s} is jointly learned by maximizing the log-likelihood as follows:

[symbol]

_{ϕ}_{ₖ}=−Σₜ₌₀^{T-1} log π_{t,k}^{s}(aₜ|sₜ), (7)

As mentioned herein, imitation reward also serves as feedback to the high-level policy training. The imitation reward r_{t,k} of HIL with behavioral cloning is obtained by the cross entropy as follows:

r_{t,k}=−Σ_{c=1}^{M}π_{E}(a_{c}|sₜ)log π_{t,k}^{s}(a_{c}|sₜ), (8)

where a_{c} is the c^{th} action and M is the total number of actions. The model is trained with coordinate descent by jointly minimizing the regression loss defined in Eq. (3) of high-level policy π^{h} and the maximizing the likelihood defined in Eq. (7).

A description will now be given regarding HIL with Adversarial Imitation Learning, in accordance with an embodiment of the present invention. Adversarial imitation learning mimics the expert policy by matching the distributions state-action pairs from expert policy and the learned policy. The output of the discriminator can be considered as a reward signal.

Adversarial imitation learning is utilized to learn π_{t,k}^{s} at time step t by minimizing the Jensen-Shannon divergence between expert' policy π_{E} and the learned policy π_{t,k}^{s} as follows:

$${ℒ}_{{ϕ}_{k}} = {D}_{K L} ( {ρ}_{{π}_{t , k}^{s}} ‖ \frac{{ρ}_{{π}_{t , k}^{s}} + {ρ}_{{π}_{E}}}{2} ) + {D}_{K L} ( {ρ}_{{π}_{E}} ‖ \frac{{ρ}_{{π}_{t , k}^{s}} + {ρ}_{{π}_{E}}}{2} ) , \qquad ( 9 )$$

where ρ_{π}(s, a)=π(a|s) Σₜ₌₀^{T} γ P(sₜ=s|π) is the distribution of state-action pairs with policy π. γ is the discounting factor, and the successor states are drawn from P(s|π). A three-layer generative adversarial network is used to minimize the Jensen-Shannon divergence via a generator πₖ^{s} parameterized with ϕₖ and a discriminator D_{ω} with the following objective function:

$${max}_{ω} {min}_{{ϕ}_{k}} {𝔼ρ}_{{π}_{t , k}^{s}} [ log ( {D}_{ω} ( s , a , ) ) ] + {𝔼ρ}_{{π}_{E}} [ log ( 1 - {D}_{ω} ( s , a , ) ) ] \qquad ( 10 )$$

The reward r_{t,k} can then be obtained from the discriminator as described below,

$${r}_{t , k} = log {{D}_{ω} ( {s}_{t} , at \vert}_{at = {π}_{k}^{s}} ( st ) ) ) \qquad ( 11 )$$

A description will now be given regarding a Full Objective Function, in accordance with an embodiment of the present invention. To summarize, the loss of HIL that is being minimized is:

[symbol]

_{HIL}=−Σₜ₌₁^{T}Σₖ₌₁^{k} [symbol] _{θ}_{_{t,k}}+ [symbol] _{ϕ}_{ₖ}. (12)

The training of HIL is summarized in Algorithm 1 for sub-policy and high-level policy learning.

K sub-policies are pre-trained followed by simultaneously optimizing high-level policy π^{h} with parameters {θ₁, . . . , θ_{K}} and low-level policy {πₖ^{s}}Kₖ₌₁ with parameters {Ø₁, . . . , Ø_{K}}.

A description will now be given regarding Algorithm 1 Policy Learning in HIL, in accordance with an embodiment of the present invention.

```
Require: Expert trajectories [symbol] ; buffer [symbol] ₖ; horizon T; smooth factor α.
  1: [symbol]  pre-training
  2: Initialize sub-policies πₖ^{s}, κ ϵ [1, ..., K] with K clusters generated
  from expert trajectories.
  3: for t = 1 to T do
  4: Aₜ ← π^{h}(sₜ, α, Θ),
  5: Take the sub-policy πₖ^{s}, which corresponds to arm Aₜ,
  6: Calculate imitation reward r_{t,k} based on Eq. (8) or Eq. (11)
  7: [symbol]  sub-policy learing
  8: Update πₖ^{s}, by the gradient [symbol] _{B}_{ₖ} [∇ ∅_{K} log πₖ^{s}(α|s)] D (s,a),
  9: Calculate diversity reward rₜ^{div} among sub-policies with Eq. (6),
10: [symbol]  high-level policy learing
11: Update π^{h} via θ_{t,k} = (X_{t,k}^{T}X_{t,k} + λI_{t,k})⁻¹X_{t,k}^{T}R_{t,k}
12: end for
13:
14: function π^{h} (sₜ, α, Θ),
15: Aₜ = arg max_{kϵ[0,k]}(s_{t,k}^{T}θₖ + α{square root over (s_{t,k}^{T}C − 1ₖs_{t,k}),)}
16: Take the high-level action with smooth operator Δ(Aₜ),
17: Select the sub-policy πₖ^{s} corresponding to Aₜ,
18: end function
```

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for hierarchical multi-agent imitation learning, comprising:
learning sub-policies for sub-tasks of a hierarchical multi-agent imitation learning task by imitating expert trajectories of expert demonstrations of the subtasks with guidance from a high-level policy corresponding to the hierarchical multi-agent imitation learning task;
collecting feedback from the sub-policies relating to updating the high-level-policy with a new observation; and
updating the high-level policy with the new observation responsive to the feedback from the sub-policies,
wherein the high-level policy is configured as a contextual multi-arm bandit that sequentially selects k best sub-policies at each of a plurality of time steps based on contextual information derived from the expert demonstrations.

2. The computer-implemented method of claim 1, wherein the k best sub-policies maximize an amount of total rewards over a subsequent time period.

3. The computer-implemented method of claim 1, combining various ones of the sub-tasks to form encompassing subtasks that imitate more complex behaviors corresponding to the encompassing subtasks.

4. The computer-implemented method of claim 1, wherein the sub-policies represent arms of the contextual multi-arm bandit.

5. The computer-implemented method of claim 1, wherein the hierarchical multi-agent imitation learning is configured to generate basic skills in a given domain.

6. The computer-implemented method of claim 1, further comprising forming the high-level policy to govern a derivation of the lower-level policy as latent interactions among subtasks of the hierarchical multi-agent imitation learning task.

7. The computer-implemented method of claim 1, forming a neural network model for learning the sub-policies.

8. The computer-implemented method of claim 1, wherein the contextual multi-arm bandit observes a current state and the sub-policies, wherein the sub-policies are considered arms of the contextual multi-arm bandit corresponding to different expert demonstration domains.

9. The computer-implemented method of claim 8, wherein the current state comprises multiple symptoms of the patient relating to comorbidity, and the arms comprise doctors in different departments.

10. The computer-implemented method of claim 1, further comprising dividing the hierarchical multi-agent imitation learning task into a high-level learning stage having a high-level state, a high-level action, and a high-level reward function and a low-level learning stage having a low-level state, a low-level action, and a low-level reward function.

11. The computer-implemented method of claim 1, wherein the high-level state indicates a context of a current status, the high-level action comprises at least some of a plurality of low-level actions, the high-level reward function provides a reward at each timestep by comparing selection sub-actions of the high-level policy against the actions in the expert demonstrations.

12. The computer-implemented method of claim 1, wherein the low-level state indicates a context of a current status, the low-level action is respectively generated by each individual one of the sub-policies, and the level reward function generates a reward for the high-level policy.

13. The computer-implemented method of claim 1, wherein the high-level policy shortens the respective horizon for each sub-policy.

14. The computer-implemented method of claim 1, wherein the sub-policies are learned by a plurality of primitive agents using behavior cloning.

15. The computer-implemented method of claim 1, further comprising generating a prediction based on a model learned from the sub-policies, and controlling a hardware machine to place the hardware machine in a safe operating mode from an unsafe operating mode responsive to the prediction.

16. The computer-implemented method of claim 1, wherein a reward feedback is set as a similarity between expert actions in respective ones of the expert demonstrations and agent actions selected by the contextual multi-arm bandit.

17. A computer program product for hierarchical multi-agent imitation learning, the computer program product comprising a non-transitory computer readable storage medium having program instructions embodied therewith, the program instructions executable by a computer to cause the computer to perform a method comprising:
learning sub-policies for sub-tasks of a hierarchical multi-agent imitation learning task by imitating expert trajectories of expert demonstrations of the subtasks with guidance from a high-level policy corresponding to the hierarchical multi-agent imitation learning task;
collecting feedback from the sub-policies relating to updating the high-level-policy with a new observation; and
updating the high-level policy with the new observation responsive to the feedback from the sub-policies,
wherein the high-level policy is configured as a contextual multi-arm bandit that sequentially selects k best sub-policies at each of a plurality of time steps based on contextual information derived from the expert demonstrations.

18. The computer program product of claim 17, wherein the k best sub-policies maximize an amount of total rewards over a subsequent time period.

19. The computer program product of claim 17, combining various ones of the sub-tasks to form encompassing subtasks that imitate more complex behaviors corresponding to the encompassing subtasks.

20. A computer processing system for hierarchical multi-agent imitation learning, comprising:
a memory device for storing program code; and
a processor device operatively coupled to the program code for running the program code to
learn sub-policies for sub-tasks of a hierarchical multi-agent imitation learning task by imitating expert trajectories of expert demonstrations of the subtasks with guidance from a high-level policy corresponding to the hierarchical multi-agent imitation learning task;
collect feedback from the sub-policies relating to updating the high-level-policy with a new observation; and
update the high-level policy with the new observation responsive to the feedback from the sub-policies,
wherein the high-level policy is configured as a contextual multi-arm bandit that sequentially selects k best sub-policies at each of a plurality of time steps based on contextual information derived from the expert demonstrations.
